(19) United States
(12) Patent Application Publication
(10) Pub. No.: US 2005/0234867 A1
(43) Pub. Date: Oct. 20, 2005

(54) Method and apparatus for managing file, computer product, and file system

(75) Inventor: Yoshitake Shinkai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/151,197

(22) Filed: Jun. 14, 2005

Related U.S. Application Data
(63) Continuation of application No. PCT/JP02/13252, filed on Dec. 18, 2002.

(51) Int. Cl. G06F 7/00

(52) U.S. Cl. 707/1

(57) ABSTRACT

A file management apparatus that manages, in a distributed manner, a file and Meta data for the file in a file system in which a plurality of file servers can share a same file, includes an assigned-file processing unit that writes Meta data of a file in a storage unit that is shared by all of the file management apparatuses, the Meta data including management assigning information indicating that the file created upon acceptance of a file creation request is a target file for a management assigned; and an assignment determining unit that determines whether a file for which an operation request is accepted is the target file, based on the management assigning information included in the Meta data written in the storage unit.

### BACKGROUND OF THE INVENTION

1) Field of the Invention

The present invention relates to a technology for achieving a scalable extending of a processing capability of a file system by reducing overhead due to a change of a file server that manages Metadata and eliminating a need for a change of file identification information caused by movement of the Metadata.

2) Description of the Related Art

Recently, a technology of distributing management of Metadata to a plurality of file servers has been developed in cluster file systems that allow the file servers to share the same file. The Metadata mentioned here is data used for file management such as names of files and directories and storage positions of file data on a disk and so on. When only a particular file server manages the Metadata, the load is concentrated only-on the particular file server, which causes degradation of performance of the whole system. Therefore, distribution of the management of the Metadata to the file servers allows improved scalability of the cluster file system.

A system that dynamically changes a file server (Metadata server) that manages Metadata for each file is disclosed in, for example, Frank Schmuck, Roger Haskin, “GPFS: A Shared-Disk File System for Large Computing Clusters”, Proc. of the FAST 2002 Conference on File and Storage Technologies, USENIX Association, January, 2002, focusing on a locality of a file access that can be assumed to be present in each file server. This system sets a file server, to which a file access is requested, as a Metadata server of the file. If locality of a file to be accessed is present in each file server, this system is effective in such a point that the process is completed within a single file server, which does not cause extra communications to be performed between file servers.

In this system, however, a location of a Metadata server is impossible to be predicted in advance, and therefore, it is difficult to predict how frequently communications are performed between file servers. There is such a defect that an enormous amount of communications between file servers may occur caused by Metadata access, particularly, during a file operation such as an operation of reading a directory with attribute. Furthermore, there is another defect such that a complicated protocol is required for decision of a Metadata server.

As a system of resolving the defects of the system that dynamically changes the Metadata servers, there is a system of deciding a statically deciding a Metadata server. For example, there is a system of dividing a name space of the cluster file system into a plurality of partitions, assigning management of each of the partitions to each of Metadata servers, and causing each of the Metadata servers to manage Metadata for a file belonging to the partition assigned. However, even if a Metadata server that manages a partition is simply assigned statically to the partition, the defects cannot be resolved. For example, if Metadata in a particular partition increases, the load of a Metadata server that manages the partition increases.

Therefore, it is necessary to dynamically divide the partition managed by the Metadata server or to change the partition managed by each of the Metadata servers. However, if the Metadata server that manages the partition is changed, the Metadata needs to be moved between Metadata servers, and overhead due to the movement increases. Furthermore, if position information for Metadata as information to identify a file is used in the file system, and if the Metadata is moved to another Metadata server due to the change of the partition, internal identification information for the file is inevitably changed.

### SUMMARY OF THE INVENTION

It is an object of the present invention to solve at least the above problems in the conventional technology.

A file management apparatus according to one aspect of the present invention, which manages, in a distributed manner, a file and Meta data for the file in a file system in which a plurality of file servers can share a same file, includes an assigned-file processing unit that writes Meta data of a file in a storage unit that is shared by all of the file management apparatuses, the Meta data including management assigning information indicating that the file created upon acceptance of a file creation request is a target file for a management assigned; and an assignment determining unit that determines whether a file for which an operation request is accepted is the target file, based on the management assigning information included in the Meta data written in the storage unit.

A file management method according to another aspect of the present invention, which is for a file management apparatus that manages, in a distributed manner, a file and Meta data for the file in a file system in which a plurality of file servers can share a same file, includes writing Meta data of a file in a storage unit that is shared by all of the file management apparatuses, the Meta data including management assigning information indicating that the file created upon acceptance of a file creation request is a target file for a management assigned; and determining whether a file for which an operation request is accepted is the target file, based on the management assigning information included in the Meta data written in the storage unit.

A computer-readable recording medium according to still another aspect of the present invention stores a computer program that causes a computer to execute the above file management method according to the present invention.

A file system according to still another aspect of the present invention, in which a plurality of file servers can share a same file, includes a Metadata storage unit that is shared by the file servers, and stores Meta data for a file. Each of the file servers accepts an operation request for the file. A file server that processes the operation request accepted is determined, based on the Meta data stored in the Metadata storage unit.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1A and FIG. 1B are diagrams for explaining a concept of Metadata management based on a cluster file system according to an embodiment of the present invention;

FIG. 2 is a functional block diagram of a system configuration of the cluster file system according to the embodiment;

FIG. 3 is a diagram of an example of a data structure of a file handle;

FIG. 4 is a diagram for explaining Metadata management based on partition division;

FIG. 5 is a diagram of an example of an assignment table;

FIG. 6 is a flowchart of a process procedure for a request acceptance unit shown in FIG. 2;

FIG. 7 is a flowchart of a process procedure for a file operation unit shown in FIG. 2;

FIG. 8 is a flowchart of a process procedure for an inode allocation unit shown in FIG. 2;

FIG. 9 is a flowchart of a process procedure for an inode release unit shown in FIG. 2;

FIG. 10 is a flowchart of a process procedure for a partition division unit shown in FIG. 2; and

FIG. 11 is a flowchart of a process procedure for a recursive partition division process shown in FIG. 10.

### DETAILED DESCRIPTION

Exemplary embodiments of the present invention are explained in detail below with reference to the accompanying drawings.

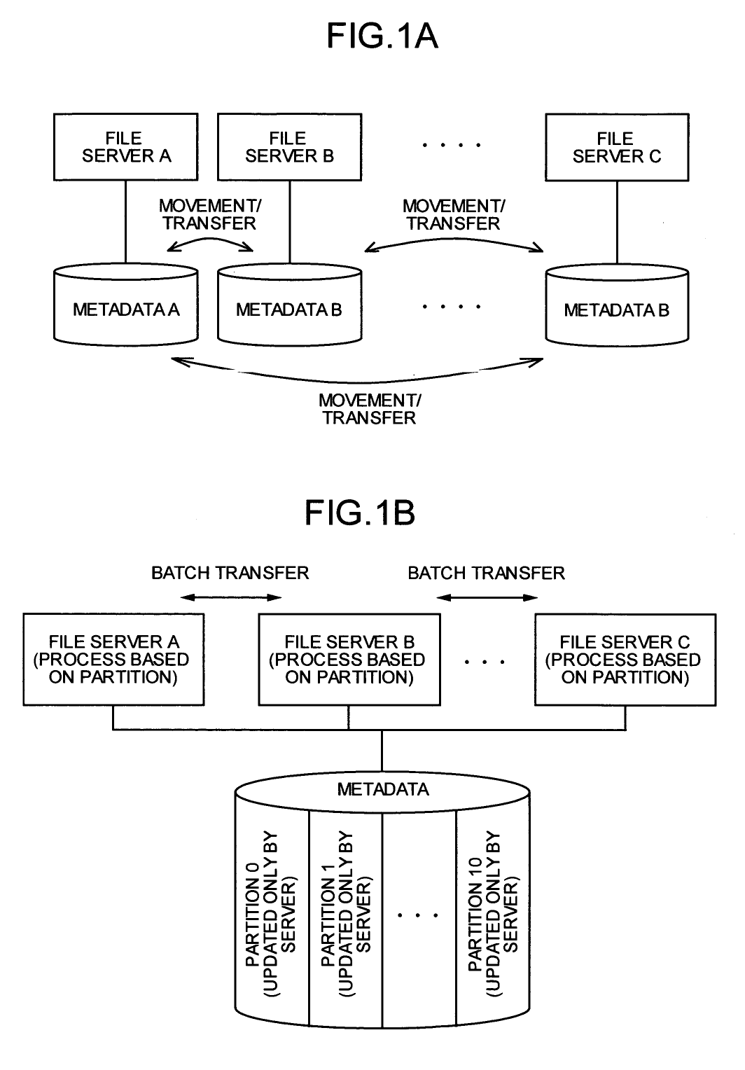

FIG. 1A and FIG. 1B are diagrams for explaining the concept of the Metadata management based on the cluster file system according to the embodiment. FIG. 1A indicates conventional Metadata management, and FIG. 1B indicates the Metadata management according to the embodiment. Although only three file servers are shown in these figures for convenience in explanation, the number of file servers can be set to an arbitrary number.

In the conventional Metadata management as shown in FIG. 1A, each file server individually manages Metadata of a file and a directory of which management is assigned to the file server. Therefore, if assignment of Metadata management is to be changed, the overhead occurs caused by movement of the Metadata to another file server. Furthermore, since information for a plurality of files belonging to one directory is distributed to various file servers, enormous amounts of Metadata need to be transferred between many file servers in order to display file attributes of the directory including many files.

On the other hand, in the Metadata management according to the embodiment, file servers share and manage Metadata using a shared disk to which all the file servers can access. Therefore, even if assignment of Metadata management is to be changed, the Metadata does not need to be moved from a change-source Metadata server to a change-target Metadata server, and information indicating the assignment of management is only rewritten in the Metadata, which allows reduction of the overhead.

However, to prevent the file servers from performing inconsistent updating on the Metadata, the Metadata is divided into a plurality of partitions, a file server is specified to manage each of the partitions, and only the file server that manages the partition can update Metadata for a file and a directory belonging to the partition. For example, Metadata with a partition number of 0 can be updated only by a file server A, Metadata with a partition number of 1 can be updated only by a file server B, and Metadata with a partition number of 10 can be updated only by a file server C.

In the Metadata management according to the embodiment, files belonging to the same directory and Metadata for the directory are collectively created in the same partition. Therefore, even in a case of a file operation for requiring a large amount of Metadata such as display of attributes of all the files that belong to a directory, batch transfer of data is possible because the Metadata for the files collectively resides in a single file server. Furthermore, it is possible to reduce overhead to collect Metadata from other file servers.

In the embodiment, as explained above, the Metadata is managed by using the shared disk to which all the file servers can access. Therefore, it is possible to reduce the overhead due to change of the assignment of Metadata management and to achieve scalable throughput of the cluster file system. Furthermore, in the embodiment, files that belong to the same directory and Metadata of the directory are collectively created in the same partition. Therefore, even in the case of the file operation for requiring a large amount of Metadata, it is possible to reduce transfer of Metadata between file servers and achieve scalable throughput of the cluster file system while ensuring stable performance.

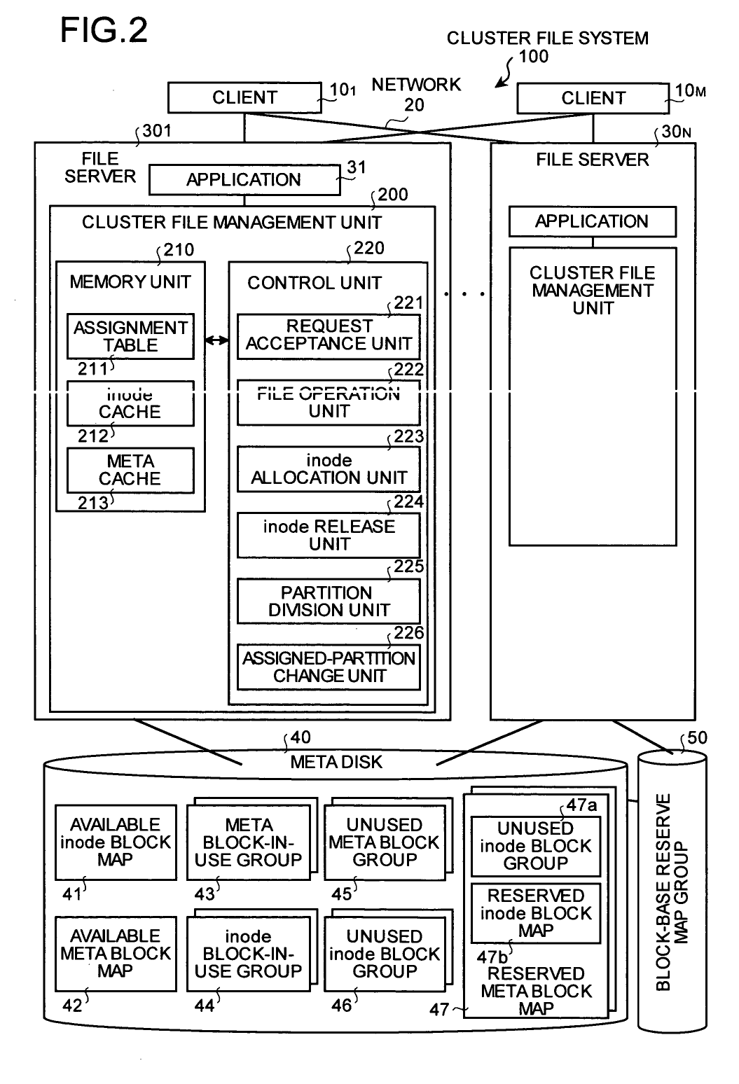

FIG. 2 is a functional block diagram of a system configuration of a cluster file system 100 according to the embodiment. The cluster file system 100 includes clients 10₁ to 10_{M}, file servers 30₁ to 30_{N}, a Meta disk 40, and a data disk 50. The clients 10₁ to 10_{M} and the file servers 30₁ to 30_{N} are connected to one another through a network 20, and the file servers 30₁ to 30_{N} share the Meta disk 40 and the data disk 50.

The clients 10₁ to 10_{M} are devices that request the file servers 30₁ to 30_{N} to perform a file process through the network 20. These clients 10₁ to 10_{M} specify a file or a directory as a target for process using a file handle to request the file servers 30₁ to 30_{N} to perform the file process. The file handle mentioned here is used for a case where the cluster file system 100 identifies a file or a directory stored in the disks. The clients 10₁ to 10_{M} receive file handles from the file servers 30₁ to 30_{N} as a result of requesting file search such as a lookup. Furthermore, the clients 10₁ to 10_{M} always use the file handles to request the file servers 30₁ to 30_{N} to perform the file process. Therefore, the file servers 30₁ to 30_{N} need to send the same file handles for the same file and directory to the clients 10₁ to 10_{M}.

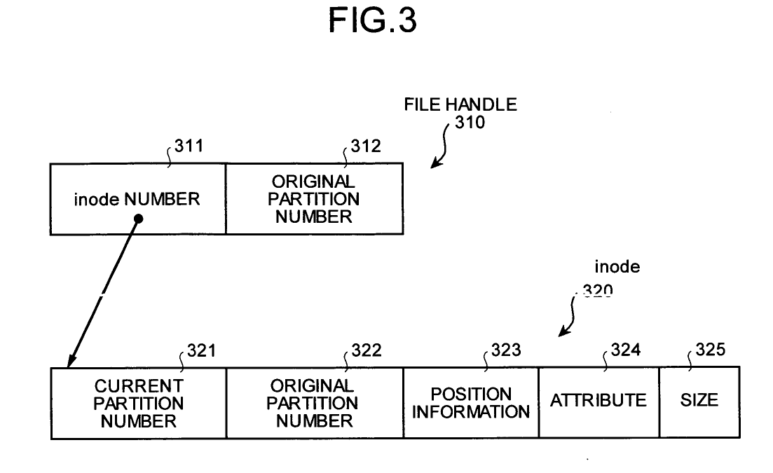

FIG. 3 is a diagram of an example of a data structure of the file handle. A file handle 310 includes an inode number 311 and an original partition number 312. The inode number 311 is a number used to identify an inode that stores information for a file or a directory, and the original partition number 312 is a number allocated to a partition as an original partition in the Meta disk 40 when a file or a directory is created. These inode number and original partition number 312 do not change until the file or the directory is deleted, which allows the file handle 310 to be made invariant as internal identification information. Details of partitions of the Meta disk 40 are explained later.

As shown in FIG. 3, an inode 320 includes a current partition number 321, an original partition number 322, position information 323, an attribute 324, and a size 325. The inode 320 functions as a file control block. The current partition number 321 is a partition number in the Meta disk 40 currently allocated to the file or the directory. The original partition number 322 is a number allocated to a partition in the Meta disk 40 when a file or a directory is created. The position information 323 indicates a position of the data disk 50 or the Meta disk 40 where data for the file or the directory is stored. The attribute 324 indicates an access attribute of the file or the directory, and the size 325 indicates the size of the file or the directory.

The partitions of the Meta disk 40 are explained below. In the cluster file system 100, the Meta disk 40 that stores the Metadata is divided into a plurality of partitions based on a name of a file or a directory and the partitions are managed. That is, the partitions are managed by the file servers 30₁ to 30_{N}, respectively.

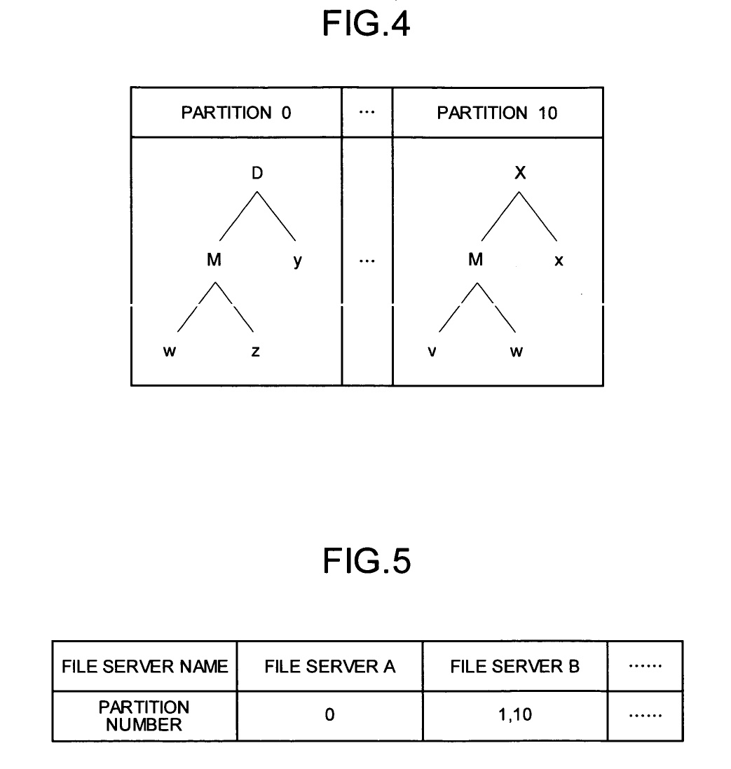

FIG. 4 is a diagram for explaining Metadata management based on partition division. FIG. 4 depicts an example of dividing a name space of a file and a directory into 11 partitions. It is shown therein that a directory D belongs to a partition with a partition number of 0 and a directory X belongs to a partition with a partition number of 10. A directory M and a file y that belong to the directory D belong to the same partition as that of a parent directory. Files w and z that belong to the directory M also belong to the same partition as that of the parent directory. That is, they belong to the partition with the partition number of 0. A directory M and a file x that belong to the directory X belong to the same partition as that of a parent directory. Files v and w that belong to the directory M also belong to the same partition as that of the parent directory. That is, they belong to the partition with the partition number of 10. However, there is a case where a partition is divided into partitions through partition division as explained later, and where a file and a directory, under a directory that belongs to one of the partitions obtained through division, are changed to belong to another partition. In this case, the partition number of the parent directory may be different from the partition number of child file and directory. Even in this case, the files that belong to the same directory and the Metadata for the directory are not dispersedly distributed to many partitions.

The file servers 30₁ to 30_{N} of FIG. 2 are computers that perform the file process of the cluster file system 100 according to a request from the clients 10₁ to 10_{M}, and manage files and directories using Metadata stored in the Meta disk 40.

The Meta disk 40 is a storage unit that stores Metadata as data used to manage files and directories of the cluster file system 100. The Meta disk 40 includes an available inode block map 41, an available Meta block map 42, a Meta block-in-use group 43, an inode block-in-use group 44, an unused Meta block group 45, an unused inode block group 46, and a partition-base reserve map group 47.

The available inode block map 41 is a control data indicating an inode block that is not used, of inode blocks that store inodes 320. The available Meta block map 42 is a control data indicating a Meta block that is not used, of Meta blocks that store Metadata.

The Meta block-in-use group 43 is a cluster of Meta blocks that are being used to store Metadata. The inode block-in-use group 44 is a cluster of inode blocks that are being used to store the inodes 320. The unused Meta block group 45 is a cluster of Meta blocks not used, of Meta blocks that store Metadata. The unused inode block group 46 is a cluster of inode blocks not used, of blocks that store the inodes 320.

The partition-base reserve map group 47 is a cluster of reserve maps created partition by partition. The reserve map includes a reserved inode block map 47a that indicates inode blocks each reserved for each partition, and a reserved Meta block map 47b that indicates Meta blocks each reserved for each partition. In the cluster file system 100, each of the partitions is managed by one of the file servers 30₁ to 30_{N}, and each of the file servers ensures a new block using the reserved inode block map 47a and the reserved Meta block map 47b for each partition when an inode block and a Meta block are required. Similarly, each of the file servers releases a block by updating the reserved inode block map 47a and the reserved Meta block map 47b for each partition when an inode block and a Meta block become unnecessary.

However, the partition with the partition number of 0 is used to manage the whole available inode blocks and available Meta blocks using the available inode block map 41 and the available Meta block map 42. Therefore, the partition-base reserve map is not provided for the partition with the partition number of 0. A file server that manages a partition with any partition number other than 0 requests the file server that manages the partition with the partition number of 0 to reserve an available inode block and an available Meta block, when the available inode block or the available Meta block reserved becomes a predetermined number or less. Likewise, a file server that manages a partition with any partition number other than 0 returns the available inode block and the available Meta block to the file server that manages the partition with the partition number of 0, when the available inode block or the available Meta block released becomes a predetermined number or more.

The data disk 50 is a storage device that stores data to be stored in files of the cluster file system 100. In the cluster file system 100, the Meta disk 40 and the data disk 50 are provided as separate disks, but both the Meta disk 40 and the data disk 50 may be configured as the same disk. Furthermore, each of the Meta disk 40 and the data disk 50 can be configured as a plurality of disks.

The file servers 30₁ to 30_{N} have the same configuration as one another, and therefore, the file server 30₁ is explained as an example of them.

The file server 30₁ includes an application 31 and a cluster file management unit 200. The application 31 is a program operating on the file server 30₁, and requests the cluster file management unit 200 to perform a file process.

The cluster file management unit 200 is a function unit that includes a memory unit 210 and a control unit 220, and performs a file process of the cluster file system 100 in response to reception of a request from the clients 10₁ to 10_{M} and the application 31.

The memory unit 210 stores data that is used by the control unit 220. The memory unit 210 includes an assignment table 211, an inode cache 212, and a Meta cache 213.

The assignment table 211 stores file server names in correspondence with numbers of partitions managed by file servers, for each file server. FIG. 5 is a diagram of an example of the assignment table 211. This figure indicates that a file server named as a file server A manages the partition with the partition number 0, and that a file server named as a file server B manages partitions with partition numbers 1 and 10. One file server manages a plurality of partitions in the above manner, and a partition managed by each of the file servers may also be changed caused by partition distribution and change of an assigned partition, which are explained later.

The inode cache 212 is a memory unit used to get quick access to the inode 320 stored in the Meta disk 40, and the Meta cache 213 is a memory unit used to get quick access to the Metadata stored in the Meta disk 40. More specifically, if access is to be made to the inode 320 and the Metadata stored in the Meta disk 40, these caches are searched first, and if the inode 320 and the Metadata are not found on the caches, then access is made to the Meta disk 40. The data updated on the inode cache 212 and the Meta cache 213 is reflected in the Meta disk 40 only by a file server that manages a partition to which the inode 320 and the Metadata belong.

In this manner, only the file server that manages the partition to which the inode 320 and the Metadata belong reflects the data updated on the inode cache 212 and the Meta cache 213, in the Meta disk 40. Therefore, it is possible to maintain consistency between the inodes 320 and the Metadata stored in the file servers.

The control unit 220 is a function unit that accepts a file operation request from the clients 10₁ to 10_{M} and the application 31, and performs a process corresponding to the file operation request. The control unit 220 includes a request acceptance unit 221, a file operation unit 222, an inode allocation unit 223, an inode release unit 224, a partition division unit 225, and an assigned-partition change unit 226.

The request acceptance unit 221 is a function unit that accepts a file operation request from the clients 10₁ to 10_{M} and the application 31, and decides a file server to process the request. More specifically, the request acceptance unit 221 receives the file operation request and the file handle 310, and reads the inode 320 from the Meta disk 40, the inode 320 being identified by an inode number of the file handle 310 received. Then, the request acceptance unit 221 decides a file server that processes the request based on a current partition number of the inode 320. However, reading data from a file and writing data to a file are performed by the request acceptance unit 221 that acquires position information for a file from the file server that manages the partition to which the inode 320 belong.

The file operation unit 222 is a function unit that processes an operation request to a file or a directory that belongs to a partition managed by a local file server. The function unit performs any process other than reading data from the file and writing data to the file. When generating a file and a directory, the file operation unit 222 writes the current partition number 321 of a parent directory in the inode 320 that stores Meta data for the file and the directory created. The file operation unit 222 writes the partition number in the inode 320 in the above manner, which allows identifying the server that manages the file and the directory created.

The inode allocation unit 223 is a function unit that acquires an inode block required when a file or a directory is created. The file server that manages the partition with the partition number of 0 acquires an available inode block using the available inode block map 41, and a file server that manages a partition with any partition number other than 0 acquires an available inode block using the reserved inode block map 47a.

The inode release unit 224 is a function unit that releases an inode block that becomes unnecessary when a file or a directory is deleted. The file server that manages the partition with the partition number of 0 updates the available inode block map 41, and the file server that manages the partition with any partition number other than 0 updates the reserved inode block map 47a. By updating these maps, the inode block is released.

The partition division unit 225 is a function unit that receives a partition division request from an operator and performs partition division. More specifically, the partition division unit 225 receives a name of a directory that is a root point of division and a new partition number from the operator, and performs a recursive process to update the current partition numbers 321 of all the files and directories under the directory as the root point. The partition division unit 225 updates the current partition numbers 321 to perform partition division, which allows efficient partition division.

The assigned-partition change unit 226 is a function unit that receives an assigned-partition change request from the operator, and dynamically changes an assigned partition. More specifically, by updating the assignment table 211, the assigned-partition change unit 226 dynamically changes a partition handled by each file server.

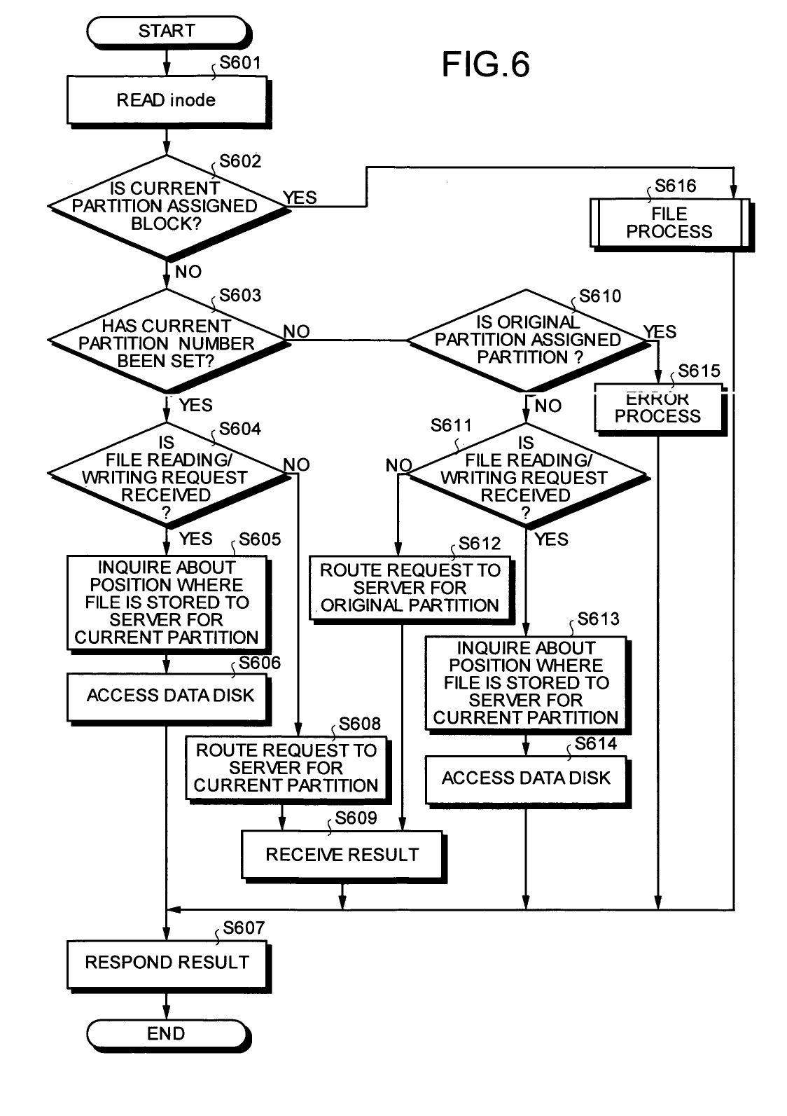

FIG. 6 is a flowchart of a process procedure for the request acceptance unit 221 shown in FIG. 2. The request acceptance unit 221 receives the file handle 310 for a file or a directory for which an operation request is accepted, and reads an inode 320 from the inode cache 212 or the Meta disk 40 using an inode number in the file handle 310 received (step S601).

The request acceptance unit 221 checks whether the current partition of the inode 320 is a partition handled by the local file server, using the current partition number 321 of the inode 320 and the assignment table 211 (step S602). If it is not the partition handled by the local file server, the request acceptance unit 221 checks whether the current partition number 321 has been set (step S603). If the current partition number 321 has been set, this case indicates that the current partition is handled by another file server. Therefore, the request acceptance unit 221 checks whether the operation request received is reading or writing of a file (step S604). If the operation request received is reading or writing of the file, the request acceptance unit 221 inquires about a position where the file is stored to the file server that handles the current partition (step S605). The request acceptance unit 221 accesses the data disk 50 based on the position received through the inquiry (step S606), and sends back the result to an operation request source (step S607).

On the other hand, if the operation request received is neither reading nor writing of a file, the request acceptance unit 221 routes the operation request to a file server that handles the current partition (step S608). When receiving the result of operation from the file server as a target routing (step S609), then the request acceptance unit 221 sends back the result received to the operation request source (step S607).

If the current partition number 321 has not been set, this case indicates that information for creation of a file or a directory is not propagated to the inode cache 212 of the local file server. Therefore, the request acceptance unit 221 checks whether the original partition is an assigned partition, using the original partition number 312 of the file handle 310 and the assignment table 211 (step S610). If it is not the assigned partition, the request acceptance unit 221 checks whether the operation request received is reading or writing of a file (step S611). If the operation request received is neither the reading nor the writing, then the request acceptance unit 221 routes the operation request to a file server that handles the original partition (step S612). When receiving the result of operation from the file server as a target routing (step S609), the request acceptance unit 221 sends back the result received to the operation request source (step S607).

On the other hand, if the operation request received is the reading or the writing, the request acceptance unit 221 inquires about a position where the file is stored to the file server that handles the original partition (step S613). The request acceptance unit 221 accesses the data disk 50 based on the position received through the inquiry (step S614), and sends back the result to the operation request source (step S607).

If the original partition of the file handle 310 is the assigned partition, the request acceptance unit 221 performs an error process (step S615), and sends back the result of the error process to the operation request source (step S607).

Furthermore, if the current partition of the inode 320 is a partition handled by the local file server, the request acceptance unit 221 performs a file process on the operation request in the local file server (step S616), and sends back the result of the file process to the operation request source (step S607).

The request acceptance unit 221 can recognize a partition number to which a file or a directory as a target for the operation request belongs, using the file handle 310 received together with the operation request and the assignment table 211, and can decide a file server that performs the file process.

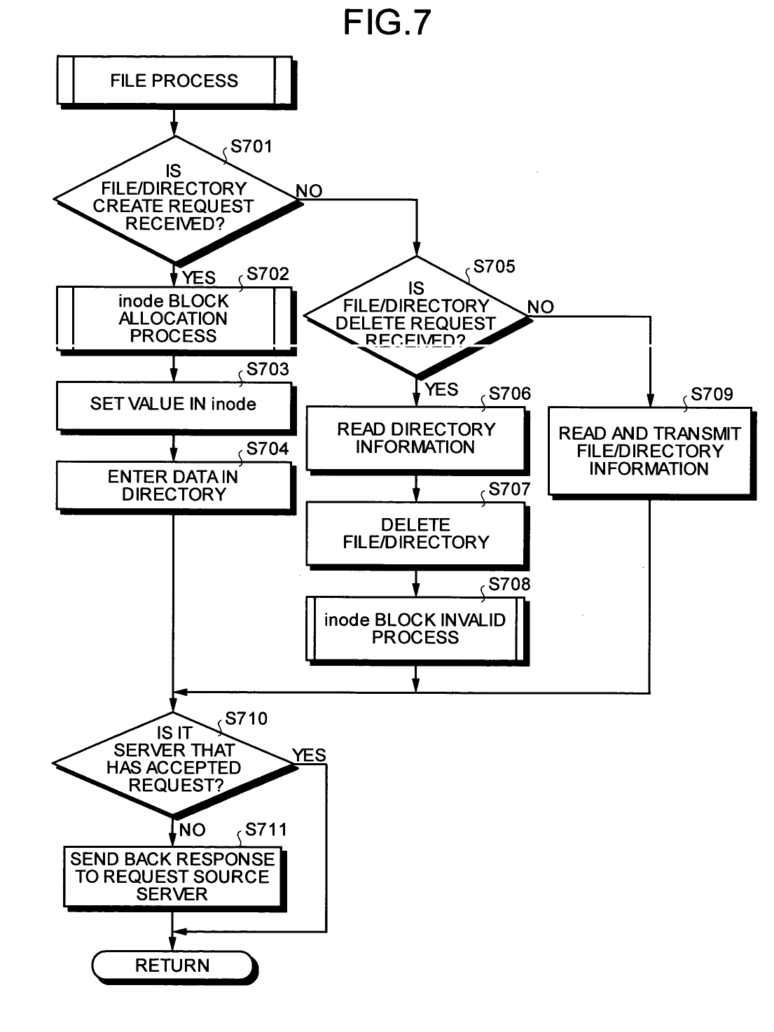

The process of the file operation unit 222 corresponds to the file process (step S616) as shown in FIG. 6. Furthermore, the file operation unit 222 performs not only a process for a process request from the local server but also a process for a process request routed thereto from another file server. FIG. 7 is a flowchart of a process procedure for the file operation unit 222 shown in FIG. 2.

As shown in FIG. 7, the file operation unit 222 checks whether a file operation request received is a create request of a file or a directory (step S701). If it is the create request of a file or a directory, the file operation unit 222 acquires an available inode block by an inode-block allocation process (step S702), sets a current partition number 321 of the inode 320 acquired and a partition number of a parent directory specified by the file handle 310 as the original partition number 322 (step S703), and enters the file or the directory created in the parent directory (step S704). The file or the directory created is classified into the same partition as that of the parent directory in the above manner.

If the file operation request received is not the create request of a file or a directory, then the file operation unit 222 checks whether the file operation request received is a delete request of a file or a directory (step S705). If it is the delete request, the file operation unit 222 reads parent directory information specified by the file handle 310 (step S706), deletes the file or the directory as a target for the delete request, updates the parent directory information (step S707), and performs an inode-block invalid process on the inode 320 that has been used for the file or the directory deleted (step S708).

If the file operation request received is not the delete request, then the file operation unit 222 reads information for the file or the directory specified by the file handle 310 and transmits the information to a file operation request source (step S709).

Subsequently, the file operation unit 222 checks whether a file server that has accepted the operation request is the local file server (step S710). If the file server is not the local file server, the file operation unit 222 sends back a response to a request source file server (step S711).

The file operation unit 222 writes the partition number of the parent directory in the current partition number 321 of the inode of the file or the directory created in the above manner, which makes it possible to specify a file server that performs a process for the operation request for the file or the directory created.

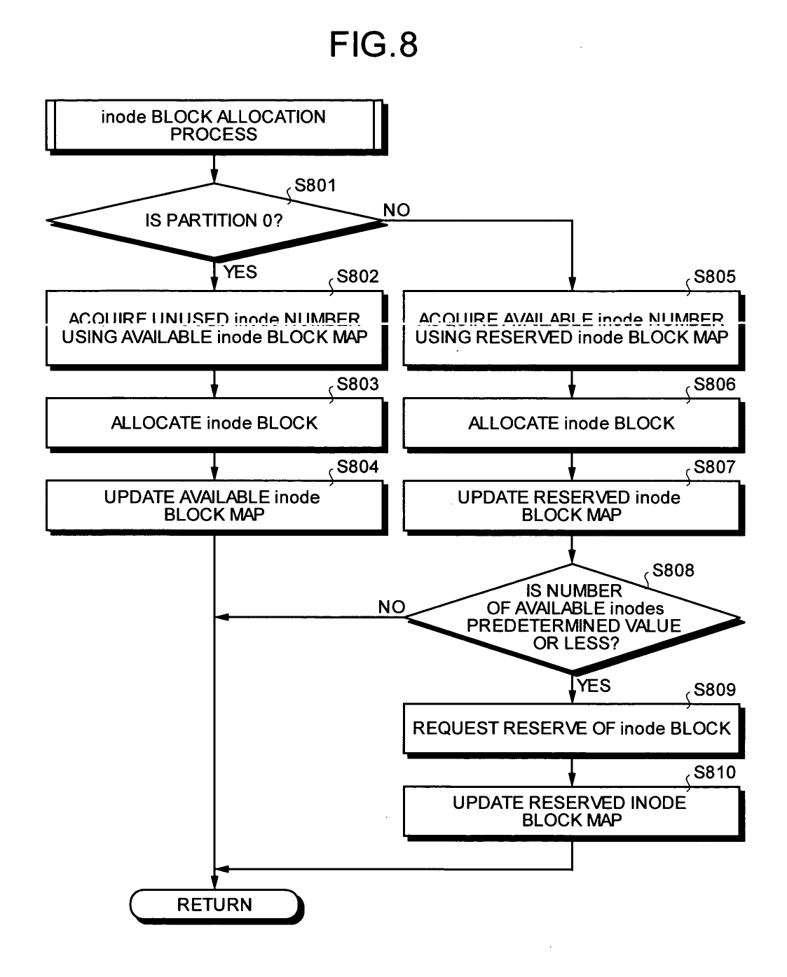

The process of the inode allocation unit 223 corresponds to the inode block allocation process (step S702) as shown in FIG. 7. FIG. 8 is a flowchart of a process procedure for the inode allocation unit 223 shown in FIG. 2.

As shown in FIG. 8, the inode allocation unit 223 checks whether a partition number of an inode block to be allocated is 0 (step S801). If the partition number is 0, the inode allocation unit 223 acquires an unused inode number using the available inode block map 41 (step S802), allocates the inode block (step S803), and updates the available inode block map 41 (step S804).

If the partition number of an inode block to be allocated is not 0, the inode allocation unit 223 acquires an available inode number using the reserved inode block map 47a corresponding to the partition number (step S805), allocates the inode block (step S806), and updates the reserved inode block map 47a (step S807). The inode allocation unit 223 checks whether the number of available inode blocks becomes a predetermined value or less (step S808). If it is not the predetermined value or less, the process is ended. On the other hand, if the number of available inode blocks becomes the predetermined value or less, the inode allocation unit 223 makes an inode reserve request (step S809), and updates the reserved inode block map 47a (step S810).

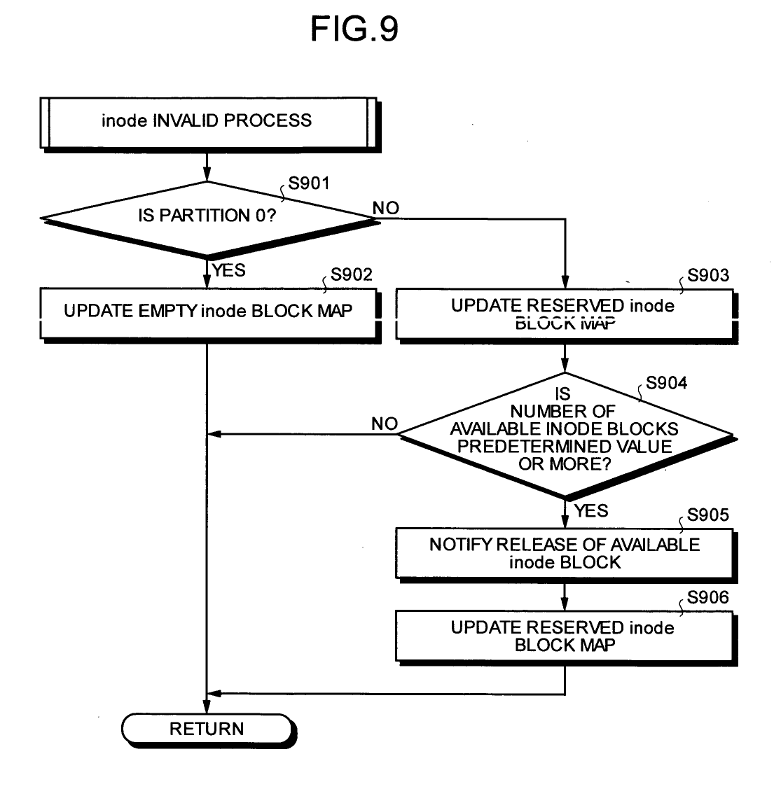

The process of the inode release unit 224 corresponds to the inode-block invalid process (step S708) of FIG. 7. FIG. 9 is a flowchart of a process procedure for the inode release unit 224 shown in FIG. 2.

As shown in FIG. 9, the inode release unit 224 checks whether a partition number of an inode block to be released is 0 (step S901). If the partition number is 0, the inode release unit 224 updates the available inode block map 41 (step S902). If the partition number is not 0, the inode release unit 224 updates the reserved inode block map 47a corresponding to the partition number (step S903), and checks whether the number of available inode blocks is a predetermined value or more (step S904). If it is not the predetermined value or more, the process is ended.

If the number of available inode blocks is the predetermined value or more, the inode release unit 224 notifies a file server that manages the partition 0 of releasing of the available inode block reserved (step S905), and updates the reserved inode block map 47a (step S906). In this case, the file server that manages the partition 0 updates the available inode block map 41, performs synchronous writing in the inodes 320, and requests the whole file servers to invalidate the inode cache.

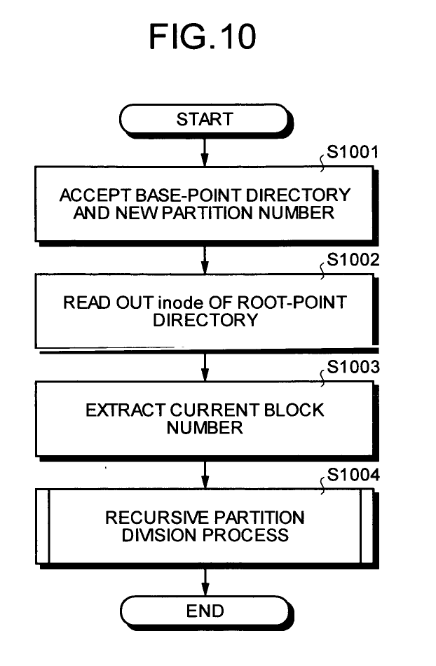

FIG. 10 is a flowchart of the process procedure for the partition division unit 225 shown in FIG. 2. The partition division unit 225 accepts a name of a root-point directory and a new partition number from the operator (step S1001), and reads out the inode 320 of the root-point directory from the Meta disk 40 (step S1002). Then, the partition division unit 225 extracts the current partition number 321 from the inode 320 read-out (step S1003), and performs a recursive partition division process (step S1004).

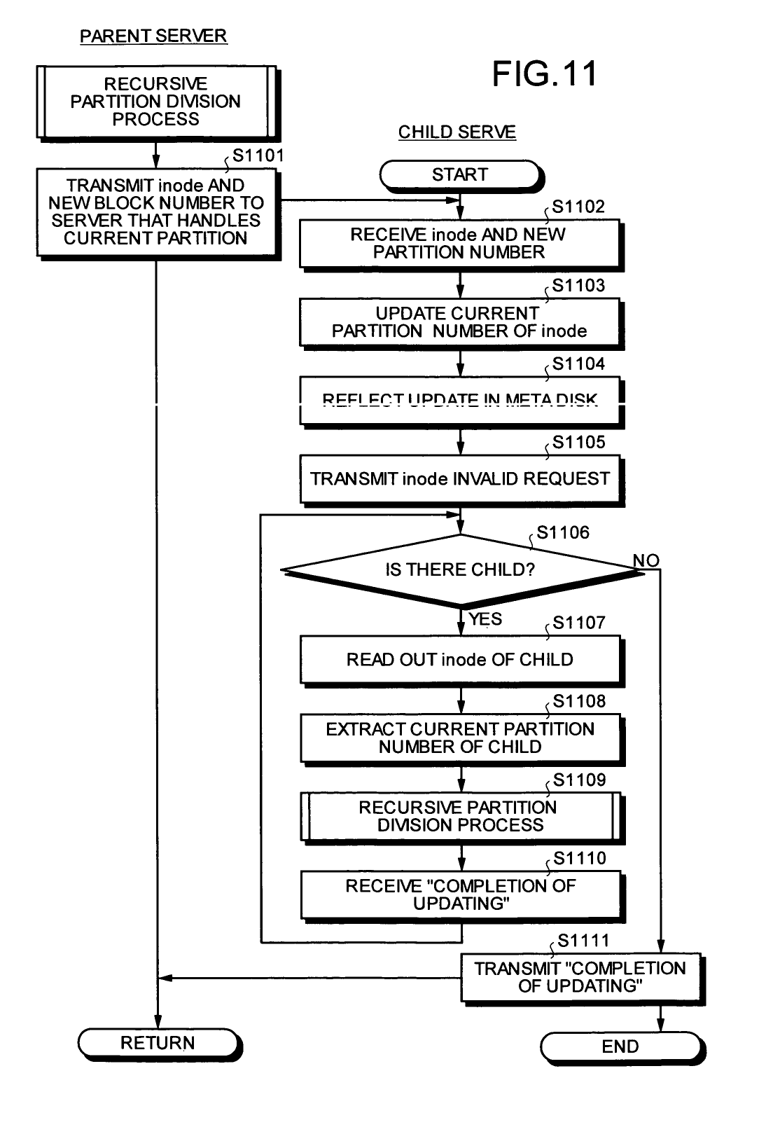

FIG. 11 is a flowchart of a process procedure for the recursive partition division process shown in FIG. 10. In the recursive partition division process, a parent file server (or a parent server) that performs a division process of the parent directory transmits the inode 320 and a new partition number to a child file server (or a child server) that handles the partition to which a child file or a child directory has belonged (step S1101). The parent file server and the child file server were the same file server at the time when the child file or the child directory was created, but they sometimes become different file servers due to partition division or change of an assigned partition.

The child file server receives the inode 320 and the new partition number (step S1102), and updates the current partition number 321 of the inode 320 in the inode cache 212 with the new partition number (step S1103). The child file server reflects the result of updating in the Meta disk 40 (step S1104), transmits an invalid request of the inode 320 updated to other file servers (step S1105), and invalidates the inode 320 of the inode cache in another file server.

When the inode 320 updated is included in a directory, the child file server checks whether the directory has a child (step S1106). If the director has a child, the child file server reads out an inode 320 of the child from the Meta disk 40 (step S1107), and extracts a current partition number 321 of the child from the inode 320 read-out (step S1108), and performs the recursive partition division process on the child (step S1109). Thereafter, when receiving “completion of updating the child” (step S1110), the process returns to step S1106, where the process for a next child is performed. If there is no child or if all the processes for the child are finished, the child file server transmits the complete of updating to the parent file server (step S1111), and ends the process.

The partition division unit 225 accepts the root-point directory and the new partition number from the operator, changes the current partition numbers 321 of all the files and directories that belong to the root-point directory using the recursive partition division process, and transmits the invalid request of the inode 320 updated to other file servers. Thus, it is possible to maintain consistency between the inodes 320 stored in the inode caches of the file servers, and to efficiently perform partition division.

The inode block is updated only by the file server that manages the partition to which the inode 320 belongs, and the updating is not simultaneously performed by the file servers. With this configuration, it is possible to prevent the inode 320 on the Meta disk 40 from being erroneously damaged.

The current partition number 321 set in the inode 320 is changed only when a file or a directory is created or deleted and when a partition is divided. Of these, creation and deletion of the file or the directory are operations that are performed frequently during normal operation. If the inode 320 is updated in synchronism with other file servers (purge of a cache and reflection thereof in the Meta disk 40), a penalty in a performance aspect is large. Therefore, the cluster file system 100 does not immediately propagate the result of updating the inode 320 to other file servers. This is because an inode 320 on the disk is uniquely determined from the inode number set in the file handle 310 that is specified based on the file operation request, and therefore, inconsistency does not occur.

In other words, there are some cases where the current partition number 321 set in the inode 320 on the meta disk becomes a temporarily inappropriate value. In one of these cases, if there has been the current partition number 321 in the past and the result of deletion of a file that has been deleted in another file server is not propagated yet, the request is routed to a file server that is decided using the current partition number 321 in the inode 320 on the meta disk. Since the file server as a target routing can recognize without fail that the file is once deleted, the file server can send back a response such that the file is no more present.

In another case thereof, a creation result of a file that has been newly created in another file server is not propagated yet, and the current partition number 321 that has been present in the past is deleted in the another file server and is newly allocated to another file in the another file server. In this case, by routing the request to a file server with the current partition number 321 set in the inode 320 on the disk, the file server can surely recognize the creation result of the file through the cache, and therefore, the current partition number is accurately recognized.

In still another case thereof, the creation result of a file that has been newly created in another file server is not propagated yet and the current partition number 321 that has been present in the past is deleted in the another file server (file server A), and then the current partition number 321 is newly allocated to another file in a different file server (file server B). In this case, because the inode 320 having been reserved by the file server A is used in the file server B, the inode 320 is surely returned to a file server that manages the partition with the partition number of 0. Therefore, to prevent overwrite of the inode 320 on the disk, synchronous writing of the inode 320 and invalidation of the inode cache are surely performed, and the result of deletion performed by the file server A is supposed to be reflected in the inode 320 on the disk.

Therefore, the partition corresponding to the file server A is impossible to be set in the inode 320 on the disk. In other words, a value indicating “not-allocated” is surely set in the current partition number 321 of the inode 320 on the disk. As a result, the routing is performed to a file server (file server B in this case) corresponding to an original partition set in the file handle 310, and the process is performed successfully.

Therefore, in the cluster file system 100, the result of updating the Metadata due to the process for an ordinary file operation request is only written in a log disk held by each file server. Thus, the Meta disk 40 can be updated by asynchronously writing the result therein at an appropriate timing through the cache.

Once partition division is performed, the current partition number 321 of the inode 320 is synchronously updated in a file server that manages the partition through the Meta disk 40. Therefore, the result of updating is instantaneously transmitted to other file servers, and no trouble on routing will occur.

According to the present embodiment, the inode 320 including Metadata for a file and a directory is stored in the Meta disk 40 that is shared by all the file servers 30₁ to 30_{N}, and the file and the directory are classified into a plurality of partitions based on their names. Then, file servers that respectively manage the partitions are specified. Then, the files, the directories, and these Metadata that belong to the partitions are separately managed by the file servers specified. The file operation unit 222 writes a partition number of a file and a directory newly created in the inode 320 of the file and the directory, and the request acceptance unit 221 decides a file server that processes a request based on the partition number that the inode 320 has. Therefore, even if the file server that manages the Metadata is changed, there is no need to move the Metadata between the file servers, which makes it possible to reduce overhead due to the change of a file server that manages Metadata and to realize the scalable cluster file system.

Furthermore, according to the present embodiment, the file operation unit 222 stores the files that belong to the same directory and the Metadata for the directory in the same partition. Therefore, even if it is necessary to collect attribute information on many files, the attribute information can be collectively transferred between file servers. Thus, it is possible to reduce overhead due to data transfer between file servers and to realize the scalable cluster file system with stable performance.

Moreover, according to the present embodiment, the inode 320 that stores information on a file and a directory is updated only by a file server that manages a partition to which the file and the directory belong, and the file server that updates the inode 320 transmits an instruction to invalidate the data in the inode cache 212, to other file servers when the inode 320 during being reserved is returned to the file server that manages the partition 0. Thus, it is possible to ensure consistency between the inodes 320 stored in inode caches of the file servers.

As explained above, according to the present invention, it is possible to reduce the overhead due to change of the file server that manages the Metadata, to eliminate the need for change of file identification information caused by movement of the Metadata, and to achieve scalable throughput of the cluster file system.

Furthermore, according to the present invention, it is possible to reduce the overhead due to change of the file server that manages the Metadata, to eliminate the need for change of file identification information caused by movement of the Metadata, and to achieve scalable throughput of the cluster file system.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A file management apparatus that manages, in a distributed manner, a file and meta data for the file in a file system in which a plurality of file servers can share a same file, the file management apparatus comprising:
an assigned-file processing unit that writes meta data of a file in a storage unit that is shared by all of the file management apparatuses, the meta data including management assigning information indicating that the file created upon acceptance of a file create request is the file to be managed by the file server creating the file; and
a file server selection unit that determines whether a file for which an operation request is accepted is the target file to be managed by the server, based on the management assigning information included in the meta data written in the storage unit.

2. The file management apparatus according to claim 1, further comprising a file classifying unit that divides a name space of files into a plurality of partitions based on a name of the file, and classifies each of the files into a partition to which the name of the file belongs, wherein
the assigned-file processing unit sets a partition identifier for identifying the partition as the management assigning information, and
the file server selection unit determines whether the file for which the operation request is accepted is the target file to be managed by the server, based on the partition identifier.

3. The file management apparatus according to claim 2, further comprising a non-assigned-file processing unit that processes an operation request for any file other than a file that belongs to a partition for which a management is assigned, based on a determination by the file server selection unit, wherein
the assigned-file processing unit performs a process for an operation request for the file that belongs to the partition for which the management is assigned, based on the determination by the file server selection unit, in addition to the file create request.

4. The file management apparatus according to claim 3, wherein
the assigned-file processing unit writes the meta data for the file created in the storage unit, as a file control block, and
the file control block includes
a current partition identifier for identifying a partition to which a file currently belongs; and
an original partition identifier for identifying a partition to which the file belongs at a time of being created.

5. The file management apparatus according to claim 3, wherein the assigned-file processing unit sets the same partition to a file and a directory created as the partition to which a parent directory under which a file and a directory is created belongs.

6. The file management apparatus according to claim 4, wherein the assigned-file processing unit includes the original partition identifier in a file handle used to specify a file based on the operation request.

7. The file management apparatus according to claim 6, wherein the file server selection unit determines whether the file for which the operation request is accepted is the target file to be managed by the file server, based on the current partition identifier and the original partition identifier.

8. The file management apparatus according to claim 2, further comprising:
a partition assignment table that stores a partition identifier of a partition that is managed by each of the file server in correspondence with each of the file server; and
a partition-assignment changing unit that dynamically changes a content stored in the partition assignment table based on an instruction from an operator, wherein
the file server selection unit determines whether the file for which the operation request is accepted is the target file to be managed, based on the content stored in the partition assignment table.

9. The file management apparatus according to claim 4, further comprising a partition division unit that changes a division of the partition.

10. The file management apparatus according to claim 9, wherein the partition division unit changes, based on a new partition identifier and a directory specified by an operator, the current partition identifier of all of the files and the directories under the directory specified to the new partition identifier.

11. The file management apparatus according to claim 10, further comprising a cache memory unit that makes a quick access to a file control block stored in the storage unit, wherein
the partition division unit issues an instruction to invalidate a file control block in which the current partition identifier is changed to the new partition identifier, from among the file control blocks stored in the cache memeory unit of other file management apparatus.

12. The file management apparatus according to claim 3, wherein the non-assigned-file processing unit includes
a non-assigned-request processing unit that receives meta data of a file for the operation request from a file server which manages the file, and processes the operation request; and
a non-assigned-request transfer unit that transfers an operation request for a file which is not managed by the file server, to other file server to which a management of the file is assigned.

13. A computer-readable recording medium that stores a computer program for a file management apparatus that manages, in a distributed manner, a file and meta data for the file in a file system in which a plurality of file servers can share a same file, wherein the computer program makes a computer execute
writing meta data of a file in a storage unit that is shared by all of the file management apparatuses, the meta data including management assigning information indicating that the file created upon acceptance of a file creation request is a target file for a management assigned; and
determining whether a file for which an operation request is accepted is the target file to be managed by the server, based on the management assigning information included in the meta data written in the storage unit.

14. The computer-readable recording medium according to claim 13, wherein the computer program further makes the computer execute
dividing a name space of files into a plurality of partitions based on a name of the file; and
classifying each of the files into a partition to which the name of the file belongs, wherein
the writing meta data includes setting a partition identifier for identifying the partition as the management assigning information, and
the determining includes determining whether the file for which the operation request is accepted is the target file to be managed by the file server, based on the partition identifier.

15. The computer-readable recording medium according to claim 14, wherein the computer program further makes the computer execute processing an operation request for any file other than a file that belongs to a partition for which a management is assigned, based on a determination at the determining, wherein
the processing includes performing a process for an operation request for the file that belongs to the partition for which the management is assigned, based on the determination at the determining, in addition to the file creation request.

16. A file management method for a file management apparatus that manages, in a distributed manner, a file and meta data for the file in a file system in which a plurality of file servers can share a same file, the file management method comprising:
writing meta data of a file in a storage unit that is shared by all of the file management apparatuses, the meta data including management assigning information indicating that the file created upon acceptance of a file creation request is a target file to be managed by the file server; and
determining whether a file for which an operation request is accepted is the target file to be managed by the file server, based on the management assigning information included in the meta data written in the storage unit.

17. The file management method according to claim 16, further comprising:
dividing a name space of files into a plurality of partitions based on a name of the file; and
classifying each of the files into a partition to which the name of the file belongs, wherein
the writing meta data includes setting a partition identifier for identifying the partition as the management assigning information, and
the determining includes determining whether the file for which the operation request is accepted is the target file to be managed by the file server, based on the partition identifier.

18. A file system in which a plurality of file servers can share a same file, the file system comprising a Metadata storage unit that is shared by the file servers, and stores meta data for a file, wherein
each of the file servers accepts an operation request for the file, and
a file server that processes the operation request accepted is determined, based on the meta data stored in the Metadata storage unit.

19. The file system according to claim 18, wherein one file server from among the file servers is set as an primary management file server that manages an available area of the Metadata storage unit.

20. The file system according to claim 19, wherein other file servers except for the primary management file server collectively reserve an available area of a predetermined size from the primary management file server, and store meta data to share and manage using the available area reserved.
